(19) United States
(12) Patent Application Publication
(10) Pub. No.: US 2016/0015102 A1
(43) Pub. Date: Jan. 21, 2016

(54) SAFETY AND IDENTIFICATION SYSTEM FOR GARMENTS

(71) Applicant: Christopher FONTE, Woodbury, CT (US)

(72) Inventor: Christopher FONTE, Woodbury, CT (US)

(21) Appl. No.: 14/331,602

(22) Filed: Jul. 15, 2014

(51) Int. Cl. A41D 27/08; F21V 33/00

(52) U.S. Cl. CPC A41D 27/085; F21V 33/0008; F21Y 2101/02

(57) ABSTRACT

An upper body garment with improved visibility includes a high-visibility face that is one of the front or back faces of the garment. The high-visibility face includes a first light emitter on a right shoulder portion and a second light emitter on a left shoulder portion. The high-visibility face further includes a first light emitter pattern formed by the first and second light emitters that grabs attention and visibly diverges when approached. The high-visibility face further includes a third light emitter that identifies the wearer.

### TECHNICAL FIELD

The system described herein generally relates to the field of apparel. More specifically, the system relates to high visibility apparel.

### BACKGROUND

High-visibility clothing has applications in a number of fields, including air travel, construction, hunting, and on roadways. Modern roadways are primarily designed for motor vehicle use, and the risk of collisions between vehicles and non-motor vehicle operators as well as low visibility vehicles (such as motorcycles) is unacceptably high. Motorists' primary attention on other motor vehicles on the road, the poor visibility of smaller motorized and non-motorized objects, and the discrepancy in speed between motor vehicles and non-motor vehicles are also factors that increase the risk of these collisions. As fuel costs and interest in physical fitness have increased, the number of bicyclists and pedestrians on roadways has also increased. This has increased the potential for collisions. These collisions are devastating for the pedestrian/bicyclist/motorcyclist and road workers because they are completely exposed and unprotected.

In order to prevent such collisions, pedestrians, bicyclists, motorcyclists and road workers frequently wear high visibility clothing or add high visibility components to their bikes, particularly at night. These high visibility clothes or components typically comprise bright colors, reflectors, or lights. However, these systems typically rely on single points of steady or flashing lights (or reflections) that may appear random or arbitrary to motorists traveling at speed. It is difficult for motorists to discern the difference and origin of the various forms of reflections and emitted lights on the roadway. Therefore, motorists' ability to determine the speed, distance, size, and identity of the cyclist/pedestrian/worker employing these systems is extremely limited.

There remains a need in the art for a recognition and visibility-increasing system for workers, motorcyclists and low-speed travelers. The system relies on a specific and recognizable pattern of emitting lights that allow motorists to quickly determine the identity of the wearer as well as the speed, distance, size, and direction of travel.

### BRIEF SUMMARY

An upper body garment with improved visibility includes a high-visibility face that is one of the front or back faces of the garment. The high-visibility face includes a first light emitter on a right shoulder portion and a second light emitter on a left shoulder portion. The high-visibility face further includes a first light emitter pattern formed by the first and second light emitters that grabs attention and visibly diverges when approached.

In some embodiments, the high-visibility face further includes a third light emitter that identifies the wearer. In some embodiments, the third light emitter includes a triangular LED cluster. In some embodiments, the third light emitter includes a line of LEDs. In some embodiments, the light emitters include LEDs. In some embodiments, the light emitters include LED clusters. In some embodiments, the third light emitter is on an abdominal portion of the high visibility face. In some embodiments, the first and second light emitters include triangular LED clusters. In some embodiments, the light emitters include LED ribbons. In some embodiments, the first and second light emitters are at the widest points of the shoulders of the high-visibility face. In some embodiments, both the front and back faces of the garment are high-visibility faces.

### BRIEF DESCRIPTION OF THE DRAWINGS

FIG. 1 is a partially transparent view of the back of a high visibility garment according to one embodiment.

FIG. 2 is a diagram of the LED array of the embodiment shown in FIG. 1.

FIG. 3 is an exploded transparent view of the power and control circuitry of the embodiment shown in FIG. 1.

FIG. 4 is a disassembled view of a portion of the garment according to the embodiment shown in FIG. 1.

FIG. 5 is a cross-sectional view taken on line 5-5 of FIG. 1.

FIG. 6 is a schematic diagram of the electronics of the embodiment shown in FIG. 1.

FIG. 7 is a partially transparent view of a high visibility garment according to the embodiment shown in FIG. 1.

FIG. 8 is a partially transparent view of a high visibility garment according to the embodiment shown in FIG. 1.

### DETAILED DESCRIPTION

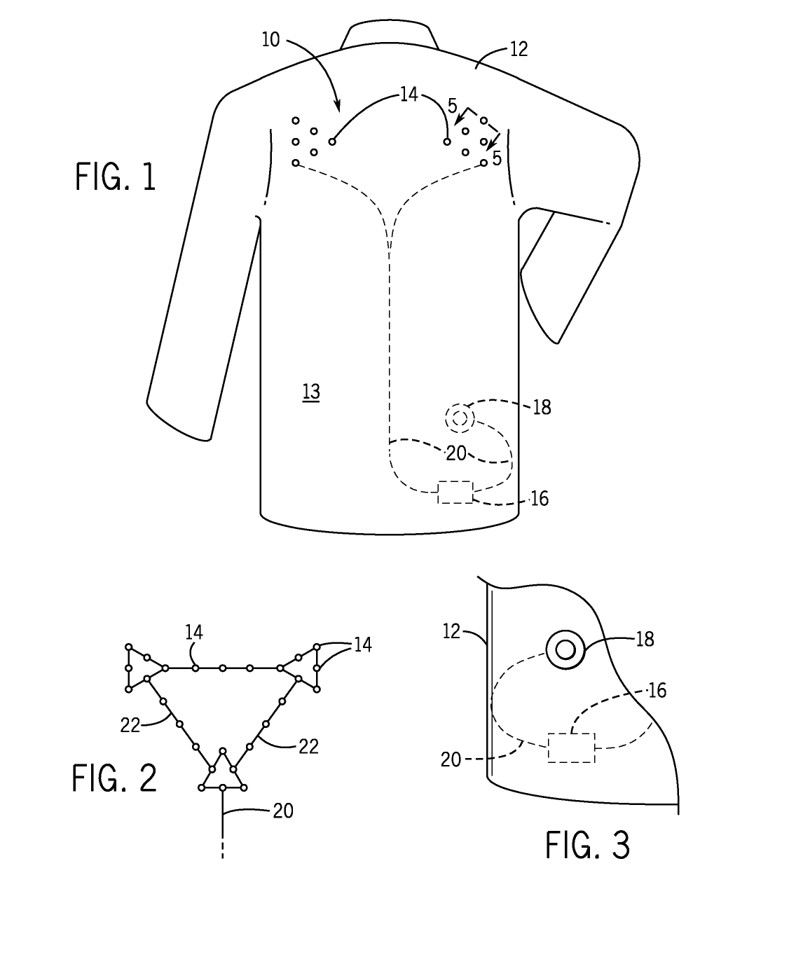

FIG. 1 is a partially transparent view of the back of a high visibility garment 12 according to one embodiment. Garment 12 (a jacket in this embodiment) comprises material 13 and visibility system 10. In this embodiment, visibility system 10 comprises LEDs 14, switch 18, a power source 16, and electrical connections 20.

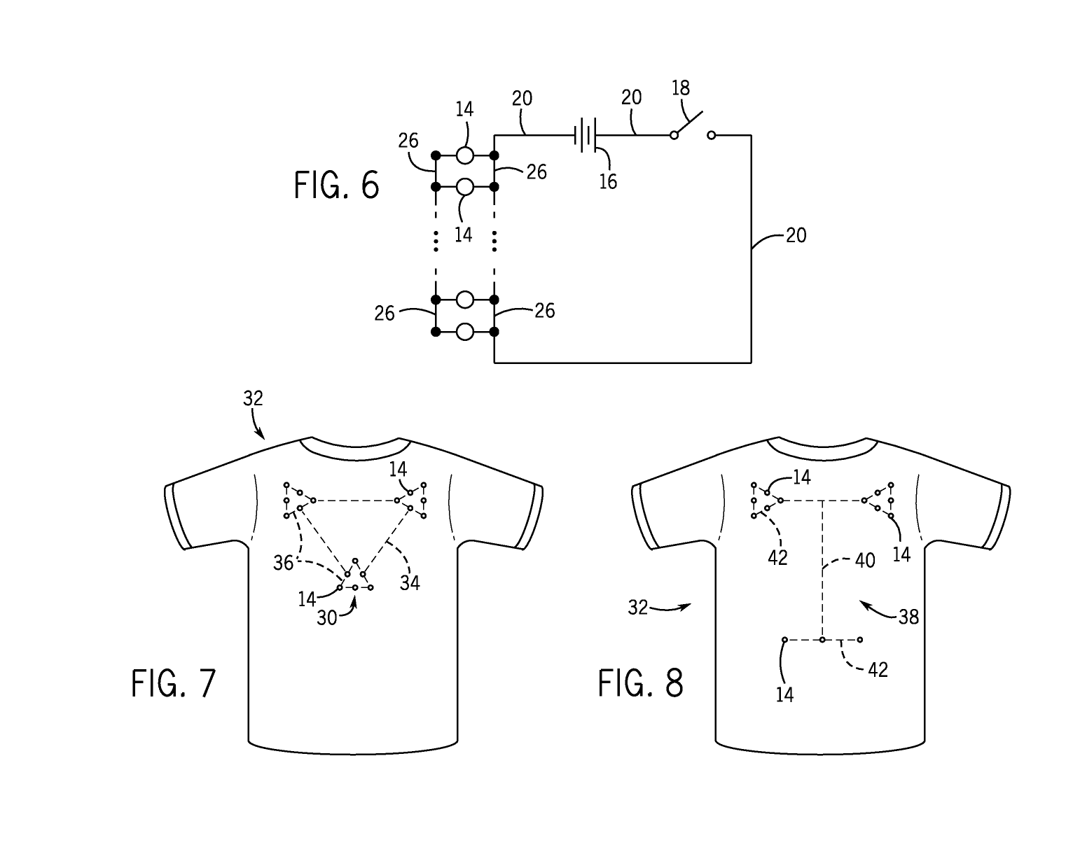

In the embodiments shown in FIGS. 2 and 7, LEDs 14 are arranged in three triangular clusters. The first and second clusters are located at the widest points of the shoulders, to maximize their distance from each other and their height on garment 12. The first and second light clusters are highly visible in order to quickly grab the attention of passing motorists. The two shoulder clusters will appear to diverge as a motorist approaches garment 12, and will appear to converge as the motorist moves away from garment 12. This optical effect allows the motorist to quickly assess the relative speed, direction, and distance of the wearer. Such information is not conveyed to a motorist by a single point of light.

The third LED cluster is located in an abdominal region (or mid/lower back) and identifies the wearer. The visible identification provided by the third LED cluster allows motorists to modify their behavior based on the wearer's presumed behavior, further enhancing safety. In this embodiment, the third cluster is a triangle identifying the wearer as a bicyclist. However, it may identify the wearer as another type of user, such as the examples mentioned herein. In the embodiment shown in FIG. 2, LED ribbons 22 connect the clusters together to enhance visibility and aid in identification.

FIG. 3 shows the power and control circuitry of system 10. These include, switch 18, power source 16, and electrical connections 20. In some embodiments, switch 18 is a simple on/off switch.

In other embodiments, switch 18 has additional functionality like the ability to toggle between different brightness, flash pattern settings, still pattern settings, or colors. In some embodiments, a wearer can toggle these settings to select different visible identification or visibility setting, depending on the intended activity. In some embodiments, an adapter is connected to system 10 to connect it to smart phones or other devices to allow users to control power, brightness, patterns, color, and flashing capabilities through an application.

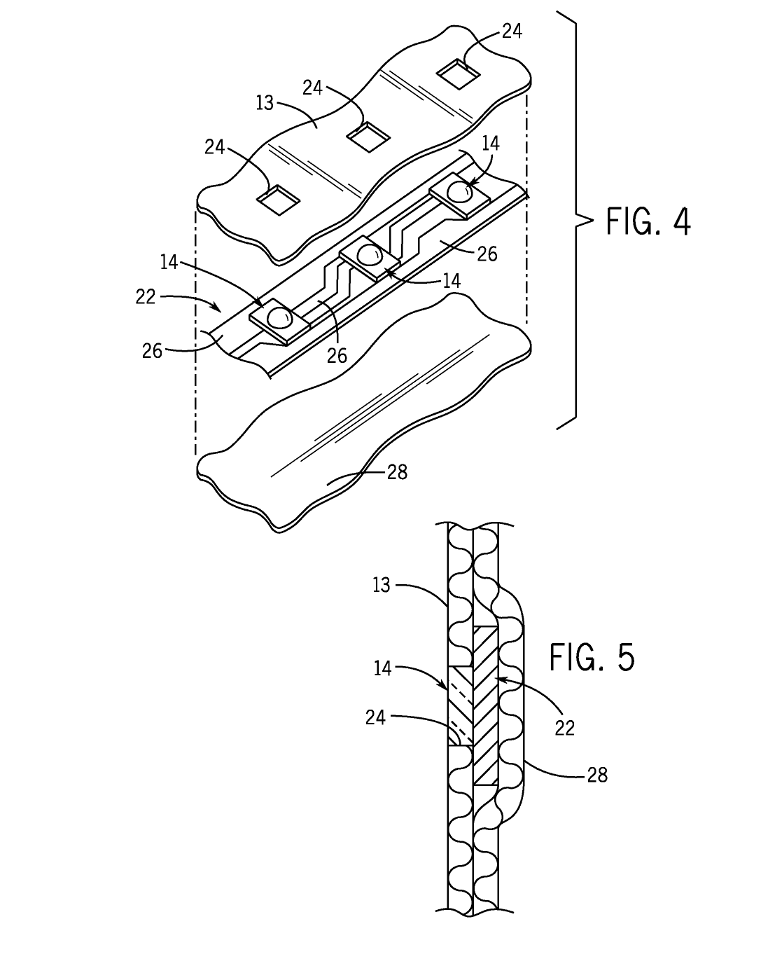

FIG. 4 is a disassembled view of a portion of garment 12. As can be seen, garment 12 comprises outer material 13, LED ribbon 22, and lining 28. LED ribbon 22 comprises electrical conductors 26 and LEDs 14. Outer material 13 comprises openings 24 that provide an unobstructed area for LEDs 14 to emit light.

FIG. 5 is a cross-sectional view taken on line 5-5 of FIG. 1, which shows the structure of FIG. 4 as assembled. Openings 24 in outer material 13 provide clearance for LEDs 14. LED ribbon 22 is disposed between outer material 13 and lining 28. LED ribbon 22 may be coupled to outer material 13, lining 28, or both. In this embodiment, lining 28 contours around the profile of LED ribbon 22. As can be seen, LEDs 14 and wiring components are incorporated into the design of garment 12 (jacket, vest, performance clothing etc.), and are sewn in to be as low profile and seamless as possible.

FIG. 6 is a schematic diagram of the electronics of system 10. Power source 16 (a battery in this embodiment) provides current through electrical connections 20 and LED ribbon conductor 26 to LEDs 14. Switch 18 opens and closes the circuit to turn LEDs 14 on and off. The system described herein may be wired using 18 AWG wire.

FIG. 7 is a partially transparent view of a high visibility garment 32 (a shirt in this embodiment) featuring a second lighting pattern 30. This embodiment features a second pattern 30 of three triangular LED clusters with no LEDs 14 between the clusters. Wiring connections 34 electrically connect the clusters. This unique pattern may identify the wearer as a cyclist, pedestrian, runner, or operator of a low-speed small vehicle (i.e. an ATV, moped, personal transporter, or scooter). The clusters may comprise LED ribbons 36, or individual LEDs 14 connected to each other.

FIG. 8 is a partially transparent view of a high visibility garment 32 (a shirt in this embodiment) featuring a third lighting pattern 38. This embodiment features the shoulder light clusters for high visibility and to communicate speed, distance, and direction to motorists. It also features an LED ribbon 42 in the abdominal area that has a horizontal linear LED 14 pattern. This pattern may indicate that the wearer is, for example, a runner. However, it could signify any of the other types of wearers, including the examples mentioned herein. Electrical connections 40 connect identity cluster with the speed/distance/direction cluster. In this embodiment, the shoulder clusters 42 are constructed from LED ribbons 42. As can be seen from the various embodiments, the LEDs 14 may be features on the back or front of the garment 12, or both. The embodiment shown in FIG. 1 is similar to that of FIG. 8, but without the LED ribbon 42.

Although the invention has been described with reference to embodiments herein, those embodiments do not limit the invention. Modifications to those embodiments or other embodiments may fall within the scope of the invention.

What is claimed is:

1. An upper body garment with improved visibility, comprising:
a high-visibility face that is one of the front or back faces of the garment, comprising:
a first light emitter on a right shoulder portion of said high-visibility face;
a second light emitter on a left shoulder portion of said high-visibility face; and
a first light emitter pattern formed by said first and second light emitters that grabs attention and visibly diverges when approached.

2. The garment of claim 1, further comprising:
a third light emitter on said high-visibility face that identifies the wearer.

3. The garment of claim 2, wherein said third light emitter is on an abdominal portion of said high visibility face.

4. The garment of claim 2, wherein said third light emitter comprises a triangular LED cluster.

5. The garment of claim 2, wherein said third light emitter comprises a line of LEDs.

6. The garment of claim 1, wherein said light emitters comprise LEDs.

7. The garment of claim 6, wherein said light emitters comprise LED clusters.

8. The garment of claim 7, wherein said first and second light emitters comprise triangular LED clusters.

9. The garment of claim 1, wherein said light emitters comprise LED ribbons.

10. The garment of claim 1, wherein said first and second light emitters are at the widest points of the shoulders of said high-visibility face.

11. The garment of claim 1, wherein both the front and back faces of the garment are high-visibility faces.
